(19) United States
(12) Patent Application Publication
(10) Pub. No.: US 2025/0181169 A1
(43) Pub. Date: Jun. 5, 2025

(54) TACTILE DISPLAY DEVICE

(71) Applicant: NEWHAPTICS CORP., Ann Arbor, MI (US)

(72) Inventors: Alexander C. RUSSOMANNO, Ann Arbor, MI (US); Richard Brent GILLESPIE, Baltimore, MD (US); Colin A. RICH, Ann Arbor, MI (US); Gregory POOL, Ann Arbor, MI (US)

(73) Assignee: NEWHAPTICS CORP., Ann Arbor, MI (US)

(21) Appl. No.: 18/966,530

(22) Filed: Dec. 3, 2024

Related U.S. Application Data
(60) Provisional application No. 63/605,938, filed on Dec. 4, 2023.

(51) Int. Cl. G06F 3/01; G09B 21/00

(52) U.S. Cl. CPC G06F 3/016; G09B 21/004

(57) ABSTRACT

A tactile display system that combines the sensing of a user's finger location and/or applied force, user input from buttons, keyboard, and scrollwheels and other user interface features, with a large array of movable pins that renders braille text and tactile graphic images such that patterns of pin movement depend on the user's finger location and/or applied force or input from buttons, keyboard, and scrollwheel or other user interface features.

### CROSS REFERENCE TO RELATED APPLICATIONS

This application claims priority to U.S. Provisional Patent Application No. 63/605,938 filed on Dec. 4, 2023, the entire disclosure of which is hereby incorporated by reference and relied upon.

### FIELD OF THE INVENTION

The present invention relates to the application of microfluidic technology for controlling and actuating thousands of pins arrayed on a flat surface to realize a device that displays refreshable tactile patterns and images to the human sense of touch.

### BACKGROUND AND SUMMARY OF THE INVENTION

A low-cost and portable device with a tablet-like form factor that features a large array of actuated pins can be used to present refreshable braille or tactile graphic figures to the fingers of people who are blind or visually impaired. Packing thousands of pins and the associated actuators into a tablet-like device to form a large pin array on a millimeter-scale grid results in a significant packaging and manufacturing challenge. For example, pins actuated to render braille dots are spaced on 2.5 mm centers, and a device with 5 lines of 40 characters in which 8 pins are dedicated to each character requires 1,600 individually actuated pins. Naturally, each pin and associated actuator must be supplied with power while individually dedicated control signals must ultimately be transduced from electronic signals so that the device may be interfaced to an electronic microprocessor. Power and control for each actuator must be sufficient to raise and hold the associated pin at least 0.25 mm above a flat surface against the pressing force of a reading finger (150 mN). Speed of actuation must be sufficient to refresh the braille text or tactile graphic figure at rates compatible with the reading and interaction speeds of human users. Instrumenting the device with a means to sense finger position and pressing force can provide additional functions. Moreover, a given design must be compact, reliable, manufacturable, serviceable, and economical. Ideally, the device is also portable, has a long life, and its design supports a composition of modules into products with various features and sizes.

As described in patent U.S. Pat. No. 10,991,269 B2; “Microfluidic Actuators with Integrated Addressing,” microfluidic technology can be used to meet the challenge of packing thousands of actuators with associated power routing, control and signaling functions, and supporting hardware into a tablet-like device. In particular, microfluidic technology can be leveraged to serve two functions, both of which are necessary for creating an economical tactile display device. First, a thin membrane covering a chamber becomes a means to interface a movable pin to a controllable pressure. The membrane is an actuator: it displaces outward when the chamber pressure increases above ambient air pressure, in turn displacing a pin. Second, a network of microfluidic memory circuits serves to reduce the number of electrofluidic transducers (valves) required to provide an individually controllable pressure to each chamber with its associated membrane and movable pin. This network of microfluidic memory circuits is conveniently manufactured in a microfluidic chip and together these circuits provide the means for the actuators to be “addressed” by a smaller number of electrofluidic valves. The functions of actuation and addressing are integrated into a single microfluidic chip in the invention described in patent U.S. Pat. No. 10,991,269 B2.

However, it can be advantageous to physically separate the addressing and actuation functions by introducing an interconnect layer, also referred to as the fluid interconnect subsystem, that fulfills additional functions. The addressing functions continue to be served by a microfluidic chip while the membrane-based actuator functions are moved off-board to a separately manufactured layer. The new interconnect layer that intervenes between the components that provide the addressing and actuator functions then provides the means to mount multiple microfluidic chips in an array, to interconnect the microfluidic chips to a bank of electrofluidic transducers, and to interconnect the microfluidic chips to the array of actuators. The intervening interconnect layer also provides a means to route fluidic power (high and low pressure) to all attached components. To serve these functions, the interconnect layer preferably features higher modulus material properties than the relatively soft microfluidic chips and the membrane upon which the actuators are based. With the introduction of the interconnect layer, the manufacturability, reliability, serviceability, and economy of the assembly can be increased. We also call the new interconnect layer the Fluidic Circuit Board (FCB) for the several parallels between its functions and those of a Printed Circuit Board (PCB) in electronic microprocessor packaging.

In brief, the function, manufacturability, and modularity of the tactile display device can be enhanced with the incorporation of the FCB. The addressing functions performed by the microfluidic chips can be combined with the electronic to fluidic transduction functions performed by the bank of electrofluidic transducers (valves) and the fluidic to mechanical transduction functions performed by the array of chambers, membranes, and movable pins. The FCB serves to securely mount all components under tight alignment requirements, enable the interconnection and routing of fluidic channels that carry either low or high pressure supplies and carry signals. Forces applied by a user to the device, whether through the surface or array of movable pins, are transmitted by the FCB to mechanical ground (device housing) while other components are protected. Further, the FCB provides a rigid substrate upon which to mount both soft and hard components of large and small size. For example, currently the maximum size of the microfluidic chips of about 43 mm square is limited by silicon wafer processing technologies while the array of moving pins that comprise the refreshable tactile graphic is on the order of hundreds of millimeters. Assembly and maintenance is also enhanced by the FCB since the device is modular so long as bonding is reversible.

The introduction of the FCB to interconnect the subsystems that perform addressing functions, actuation functions, and electrofluidic transducing functions leads to improvements in performance, including increase in actuation speeds, reduction of power consumption, and reduction in noise. The cost and complexity of the device can also be reduced. The volume of fluid contained in channels that interconnect that various subsystems is significantly reduced when subsystems are interconnected through the FCB. Especially in channels carrying signals, this reduction in volume in turn leads to increased speed of propagation of signals encoded in pressure changes. The rigidity of the FCB also prevents deterioration in the quality of the signals that might occur in the case of channels fabricated in softer materials. Changes in pressure that induce deformations in compliant walls are essentially lost rather than propagated. Further, the introduction of the FCB between the subsystem that performs addressing and the subsystem that performs actuation functions provides a means to manage design changes to one subsystem but not the other, especially when those design changes impact the geometry of the interconnections themselves. For example, a change in the layout of the interconnect to the subsystem performing actuation functions can be accommodated without updating the design of the subsystem performing addressing functions with a re-design of the FCB. Likewise, changes to the design of the FCB can be used to change the number of subsystems performing addressing functions that are interfaced to a given actuator subsystem. A family of products of various sizes may thus be developed using a single design of the addressing subsystem.

A preferred embodiment of the FCB concerns its plurality. Naturally, a single flat FCB has only two sides to which components can be mounted: top and bottom. A plurality of FCBs might be used to “sandwich” certain components, especially the microfluidic chips. Mechanical compression or the use of clamping forces might enhance the interconnection of the several power channels and many signal channels between the several microfluidic chips and the clamping FCBs. An important consideration, however, is the uniformity with which clamping forces can be applied, especially when distributed across multiple microfluidic chips and an upper and lower FCB. Differing thicknesses or non-uniformity of stress distributions developed under various clamping means can lead to non-uniform reliability of the interconnects. For such reasons, the use of microfluidic chips whose interconnects to the microfluidic chips are isolated to a single side and a single FCB with only two (top and bottom) mounting surfaces is the preferred embodiment communicated in this invention.

### BRIEF DESCRIPTION OF THE SEVERAL VIEWS OF THE DRAWINGS

The figures below illustrate selected embodiments of a portable, tactile display device. To realize a tablet-sized device, considerations in the device design, control design, assembly, and management of the fluid dynamics, all of which are tightly coupled, must be addressed.

The drawings described herein are for illustrative purposes only of selected embodiments and not all possible implementations, and are not intended to limit the scope of the present disclosure.

FIG. 1A illustrates a user employing an embodiment of a compact and portable tactile display system according to the principles of the present teaching.

FIG. 1B illustrates a cut-away view of an embodiment of the tactile display device.

FIG. 1C illustrates a schematic side view of an embodiment of the tactile display system.

FIG. 1D contains a chart showing the various components of the tactile display system and their physical interconnection.

FIG. 2A illustrates a schematic view of an embodiment of the tactile actuation system with its various internal channels, ports, and mating components.

FIG. 2B illustrates a schematic side view of the tactile actuation system with its various internal channels, ports, and mating components.

FIG. 2C illustrates an exploded (left) and assembly (right) drawing of a preferred embodiment of the tactile actuation system.

FIG. 3A illustrates a schematic side view of a preferred embodiment of the fluid interconnect subsystem.

FIG. 3B illustrates a schematic side view of an alternative embodiment of the fluid interconnect subsystem.

FIG. 3C illustrates an assembly (left) and exploded drawing of a preferred embodiment of the fluid interconnect subsystem.

FIG. 4A illustrates a schematic side view of an embodiment of the fluid actuator subsystem.

FIG. 4B illustrates an exploded view of an embodiment of the fluid actuator subsystem.

FIG. 5A illustrates a schematic of a fluid logic circuit realizing a NOT gate.

FIG. 5B illustrates a schematic of a fluid logic circuit realizing an asymmetric NOT gate.

FIG. 5C illustrates a schematic of a fluid logic circuit realizing a complementary-symmetry NOT gate.

FIG. 5D illustrates a schematic of a fluid logic circuit realizing a D Latch.

FIG. 5E illustrates a schematic of a fluid logic circuit realizing a D Latch (detail).

FIG. 5F illustrates a schematic of a fluid logic circuit realizing an addressable grid.

FIG. 5G illustrates a schematic of a fluid logic circuit realizing a shift register.

FIG. 6A illustrates an exploded view of an embodiment of an electrofluidic transducer subsystem.

FIG. 6B illustrates a side view of an embodiment of an electrofluidic transducer subsystem.

FIG. 6C illustrates an embodiment of an electrofluidic transducer based on the layered assembly of rigid substrates, o-rings, and an electronic solenoid actuator.

FIG. 6D illustrates one embodiment of an electrofluidic transducer based on the layered assembly of rigid substrates, an elastic membrane, and a piezoelectric bimorph actuator.

FIG. 6E illustrates another embodiment of an electrofluidic transducer based on the layered assembly of rigid substrates, an elastic membrane, and a piezoelectric bimorph actuator.

FIG. 7A illustrates the user interaction system, highlighting a button interface.

FIG. 7B illustrates an exploded view of an embodiment of the user interaction subsystem, highlighting the tactile output subsystem and touch-sensing subsystem.

FIG. 7C illustrates a schematic side view of an embodiment of the tactile output subsystem and touch-sensing subsystem, highlighting the interface to the fluid actuator subsystem.

FIG. 8A illustrates a schematic side view of an embodiment of the fluid pumping device.

FIG. 8B illustrates an embodiment of the condensed moisture trap, moisture release valve, and valve outlet.

FIG. 8C illustrates an alternative embodiment of the condensed moisture trap, moisture release valve, and valve outlet.

Corresponding reference numerals indicate corresponding parts throughout the several views of the drawings.

### DETAILED DESCRIPTION OF THE INVENTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

According to the principles of the present teachings, a composition of materials or a monolithic material structured with channels and chambers to be filled with fluid (gas or liquid) is provided. The pressure of such fluid can either be elevated or depressed relative to atmospheric pressure under the control of external means, such as, but not limited to, electronic valves, pumps, pressure and/or vacuum vessels, and the like. In some embodiments, control of pressure may be rapid and associated with small amounts of flow on certain channels (carrying information), while, conversely, pressure variation may be small on other channels and associated with significant amounts of flow (carrying power).

As will be described herein, the channels and chambers are variously connected and occasionally separated by walls or membranes that are compliant and therefore responsive to difference in pressure across their surfaces by virtue of their geometry (possibly thickness) or material composition. Although the present teachings will be discussed in connection with preferred embodiments, it should be understood that the present teachings should not be limited to the specifically recited embodiments. Variations of construction, materials, and arrangement are anticipated and remain within the scope of the present disclosure.

In some embodiments, the composition of materials or monolithic material with its variously arranged compliant walls or membranes is structured so as to realize three functions: 1) routing functions, 2) logic functions, and 3) actuator functions. When certain compliant walls deform under fluid pressure, logic and addressing functions are realized-akin to logic functions performed in solid-state electronics. In particular, certain flow or pressure in certain chambers or channels can be controlled by pressures (or flows) in other chambers or channels. When certain compliant walls deform under fluid pressure, actuator functions are realized. In particular, walls or membranes will displace under pressure within certain chambers and these displacements will be transmitted to an external surface of the device that can be touched by a user's finger or generate other useful output.

Although the term pressure may be used herein to describe the manner in which a signal is encoded as positive excursions from a baseline pressure, the signal should not be limited to positive excursions. That is, negative excursions relative to a baseline pressure, i.e. vacuum, can also be used to encode the signal. Also, variation in flow can be used to encode a signal. Moreover, it should be understood that the term “fluid” shall include either air or liquid. That is, the devices described herein may be construed as either pneumatic or hydraulic.

According to the principles of the present teachings, as illustrated in the figures, an apparatus and method for addressing and controlling fluid-based actuators for use in a tactile display device is described.

### Tactile Display System

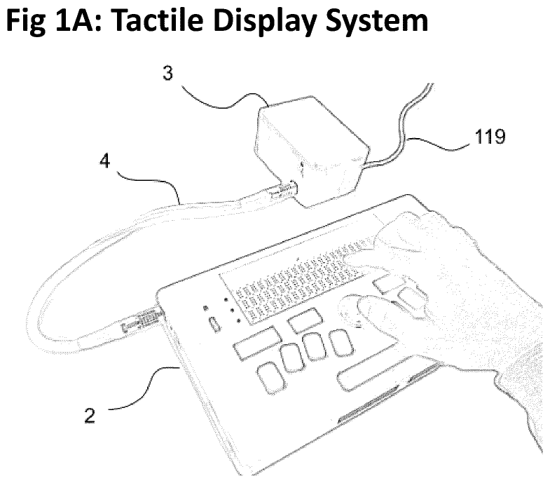

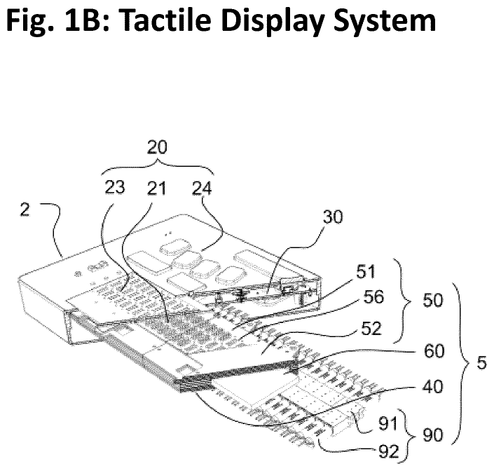

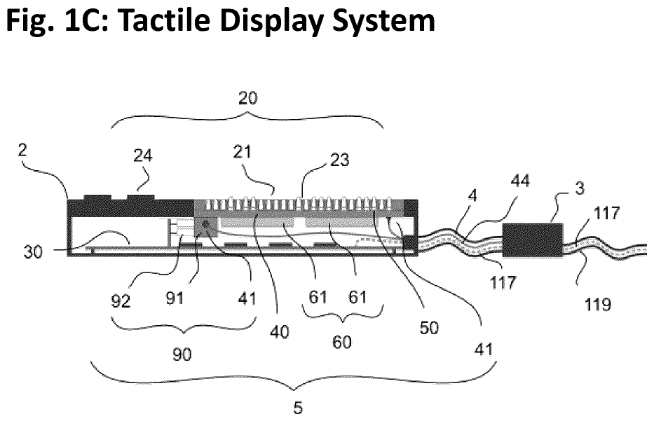

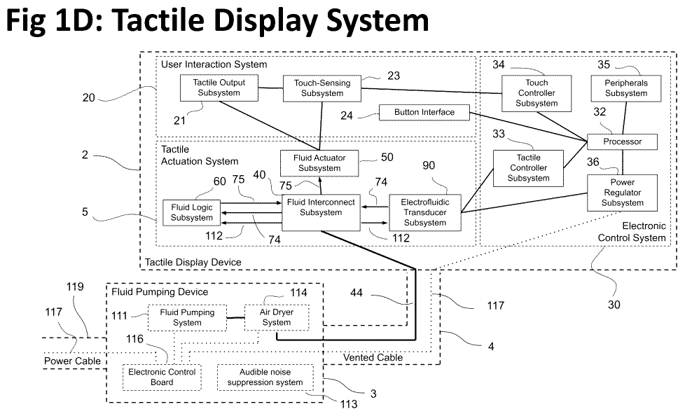

With particular reference to FIG. 1A, a tactile display system 1 is illustrated according to the present teachings comprising a tactile display device 2, a fluid pumping device 3, and a hybrid fluid-electrical cable herein referred to as a vented cable 4. With reference to FIG. 1B and FIG. 1C, the tactile display device 2 further comprises a tactile actuation system 5, a user interaction system 20, and an electronic control system 30. In one embodiment, the electronic control system 30 is an electronic printed circuit board. The tactile actuation system 5 comprises a fluid interconnect subsystem 40, a fluid actuator subsystem 50, a fluid logic subsystem 60, and an electrofluidic transducer subsystem 90. The user interaction system 20 consists of a tactile output subsystem 21, a touch-sensing subsystem 23, and a button interface 24. With reference to FIG. 1D, the electronic control system 30 comprises a power regulator subsystem 36, a tactile controller subsystem 33, a touch controller subsystem 34, and a peripherals subsystem 35. The fluid pumping device 3 consists of a fluid pumping system 111, an electronic control board 116, an audible noise suppression system 113, and an air dryer system 114.

### Generating Fluid Power and a Few Pressure-Based Inputs

In the example embodiment, with reference to the schematic side view in FIG. 1C and the diagram schematic in FIG. 1D, electrical power is carried to the electronic control board 116 in the fluid pumping device 3 through a standardized power cable 119. Electrical power is carried to the fluid pumping system 111 that then converts electrical power into fluid power in the form of pressurized air that is carried along fluid tubing 44. The audible noise suppression system 113 acts to reduce the noise emitted from the fluid pumping device 3 stemming from the process of pressurizing air. The pressurized air 112 flows next into the air dryer system 114 that both removes excess moisture from the compressed air, and also cools it below room temperature to avoid further condensation downstream of the pumping device. Pressurized air and electrical power are carried together through air tubing 44 and electrical wire 117, respectively, in a vented cable 4 that is coupled on one end to the fluid pumping device 3 and on the other end to the tactile display device 2. When pressurized air enters the tactile display device 2 via the vented cable 4, it is routed to the fluid interconnect subsystem 40 through air tubing 44. The electrical power is routed to the power regulator subsystem 36 within the electronic control system 30 using electrical wire 117. The air tubing 44 is coupled to the fluid interconnect subsystem 40 using hose barbs 41. In another embodiment, the air tubing 44 is directly coupled to the fluid interconnect subsystem 40 by press-fitting compliant tubing into precisely sized holes within the fluid interconnect subsystem 40 and using an adhesive, preferably one that is curable with ultra-violet light, to provide an additional seal around the press-fit connection. However, any suitable method may be used. Pressurized air flows through the air tubing 44 and the hose barbs 41 into fluid power channels 42 within the fluid interconnect subsystem 40. The fluid power channels 42 within the fluid interconnect subsystem route the pressurized air to both the fluid logic subsystem 60 and the electrofluidic transducer subsystem 90.

### Conversion From a Few Pressure-Based Inputs to Many Pressure-Based Outputs

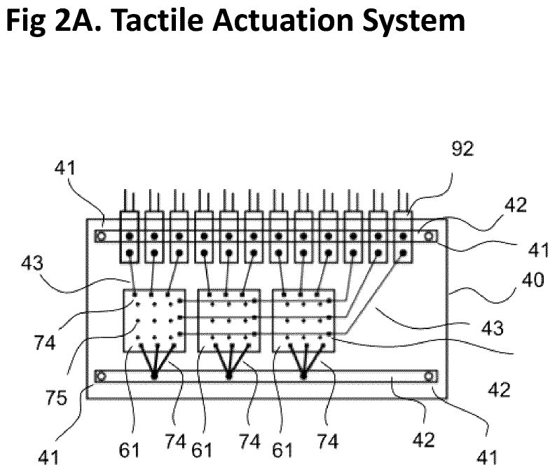

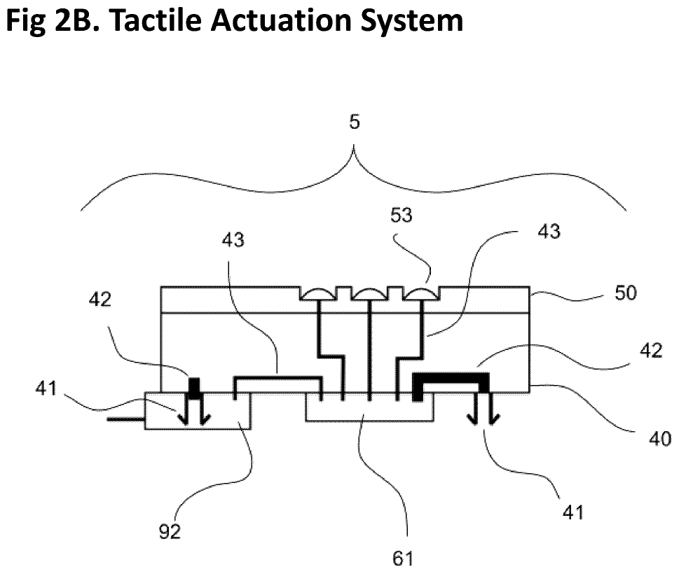

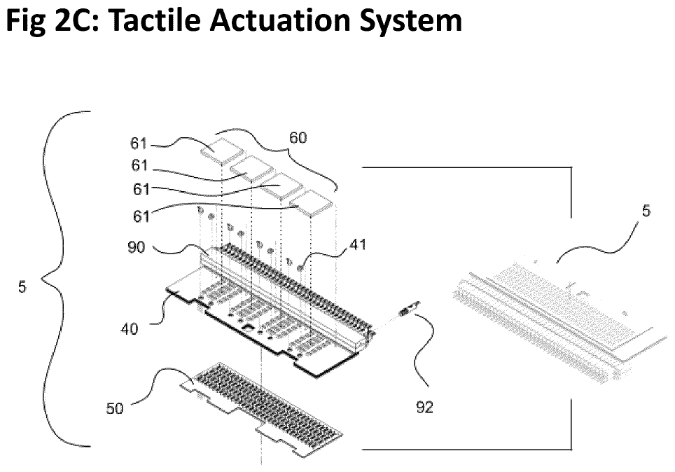

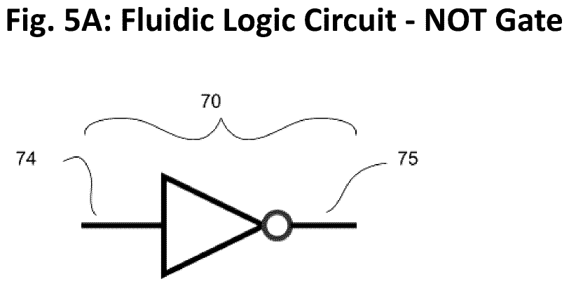

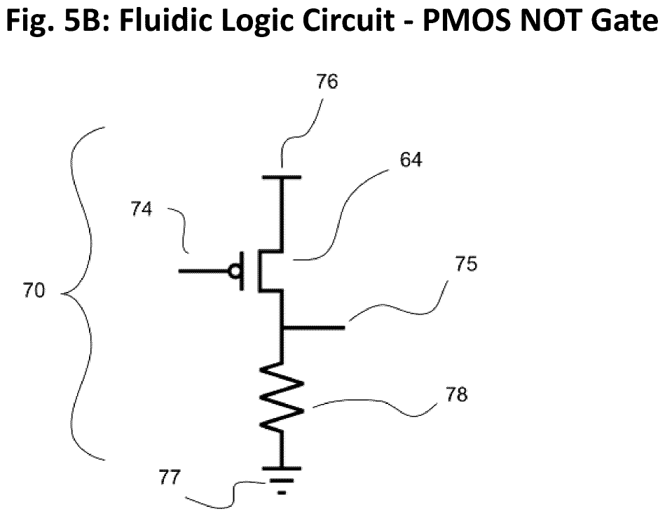

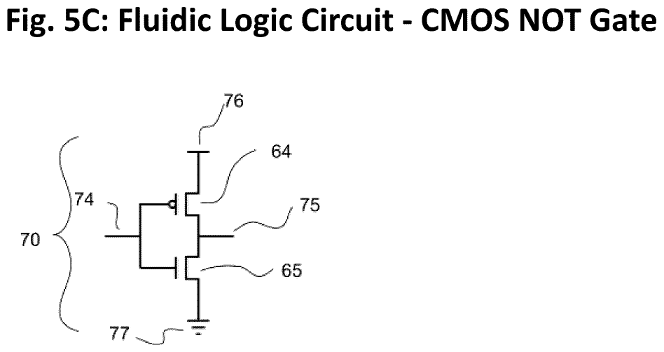

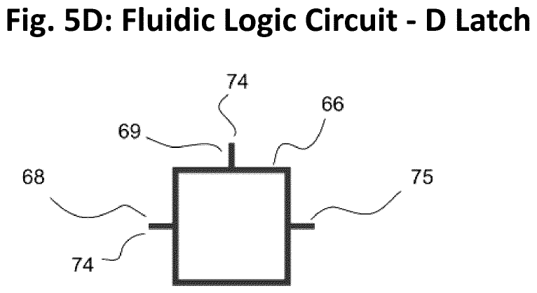

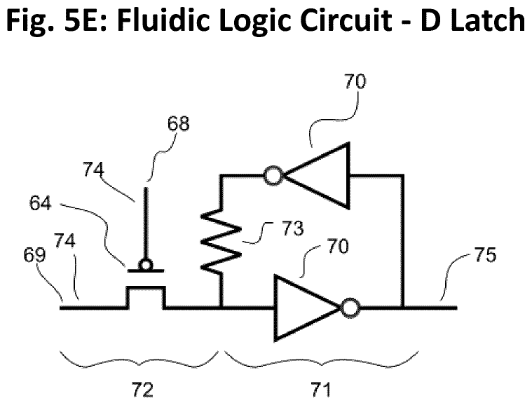

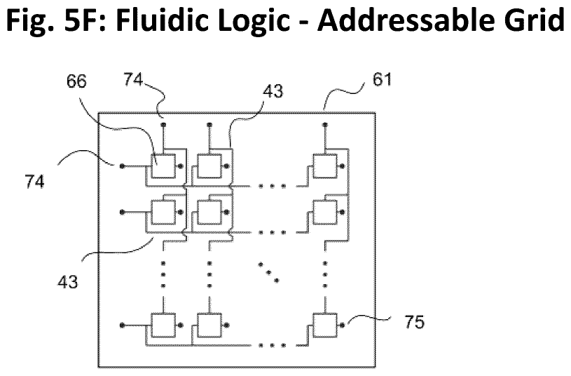

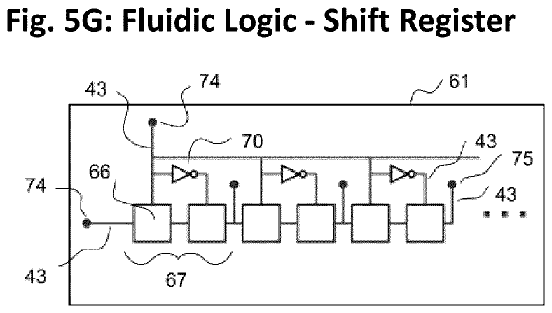

With reference to FIG. 2A, the fluid logic subsystem 60, the fluid interconnect subsystem 40, and the electrofluidic transducer subsystem 90 work together to enable the conversion of a small number of pressure-based inputs 74 into a larger number of pressure-based outputs 75. An electrofluidic transducer (valve) 92 within the electrofluidic transducer subsystem 90 generates an independent pressure-based input 74 by gating pressurized air 112 from a fluid power channel 42 within the fluid interconnect subsystem 40. Valves generate a small number of independent pressure-based inputs 74 that travel through fluid information channels 43 and connect to fluid logic circuits in the fluid logic subsystem 60. With reference to FIG. 5F, in one embodiment, the fluid logic circuits are fluidic D Latches 66 that receive pressure-based inputs 74 from fluid information channels 43 at their inputs. In response to the timing and state of the pressure-based inputs 74, many more fluid logic circuits 66 generate pressure-based outputs 75 by gating pressurized air 112 from a fluid power channel 42 within the fluid logic subsystem 60. Importantly, an addressing scheme is used in the fluid logic subsystem 60 such that one fluid information channel 43 connects one electrofluidic transducer 92 to many fluid logic circuits 62. In the example embodiment, with reference to FIG. 5F and in reference to prior patent U.S. Pat. No. 10,991,269 B2; “Microfluidic Actuators with Integrated Addressing,” the fluid logic circuits 62 are arranged in an addressable matrix design within the fluidic chips 61. According to the principles of the present teachings, and with reference to FIG. 2A, fluidic chips 61 are arranged in an addressable grid within the fluid logic subsystem 60 and are coupled to the fluid interconnect subsystem 40. The number of unique pressure-based outputs 75 greatly exceeds the number of unique electrofluidic transducers 92 in the tactile display system 1. Further, the scale of the difference in pressure-based outputs 75 to electrofluidic transducers 92 is magnified by the use of the fluid interconnect subsystem 40.

### Conversion From Pressure-Based Outputs to Movement of a Fluid Actuator

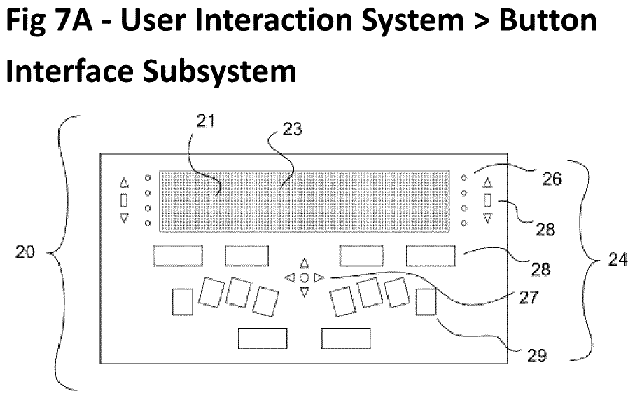

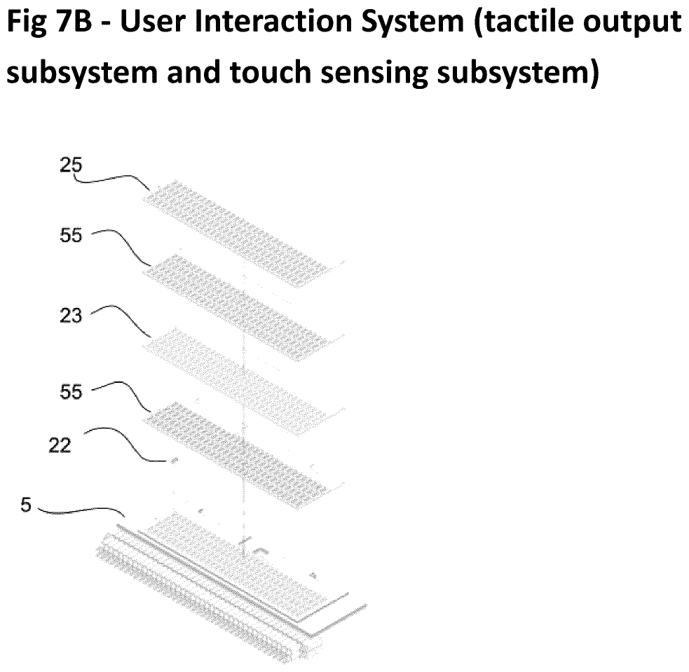

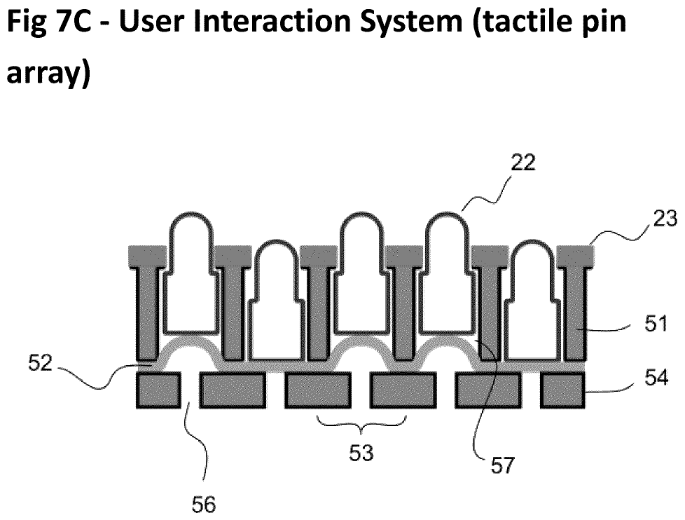

With reference to FIG. 2B, to meet the requirements of a tactile display, pressure-based outputs 75 are converted into the movement of fluid actuators 53. The pressure-based outputs generated from fluidic chips 61 travel through fluid information channels 43 within the fluid interconnect subsystem 40 to fluid actuators 53 in the fluid actuator subsystem 50. In one embodiment, the fluid actuator subsystem 50 and the fluid logic subsystem 60 are coupled to opposite faces of the fluid interconnect structure 40. A plurality of independent fluid information channels 43 carry pressure-based outputs 75 from the fluid logic subsystem 60 on one face to meso-scale ports 56 that sit beneath independent fluid actuators 53 in the fluid actuator subsystem 50. When a pressure-based output 75 is a low pressure 77, the connected fluid actuator 53 is down. When the pressure-based output 75 is a high pressure 76, the connected fluid actuator 53 is up. With reference to FIG. 7C, in one embodiment of the tactile output subsystem, tactile dots 22 are coupled to the fluid actuators 53 in the fluid actuator subsystem 50 and transfer the movement of that fluid actuator to the surface of the tactile display. In one embodiment, the touch-sensing interface 23 is coupled to the top surface of the fluid actuator subsystem 50 and is preferably a capacitive touch sensor.

### Movement of Tactile Dots in Response to User Input

With reference to FIG. 1D, to meet the requirements for user interaction, the movement of tactile dots in the tactile output subsystem 21 is mediated using an onboard processor 32 in the electronic control system 30. The timing of signals generated by electrofluidic transducers 92 is tightly controlled by the tactile control subsystem 33 to achieve the accurate and rapid refresh of the tactile dots on the surface. The onboard processor 32 also mediates user input from the button interface 24 and the touch-sensing subsystem 23 via the touch controller subsystem 34. Tactile dots 22 are raised and lowered in response to user input, closing the loop with the user to achieve a tactile display system.

### Tactile Actuation System

With particular reference to FIG. 2A, a tactile actuation system 5 is illustrated according to the present teachings. The tactile actuation system comprises a fluid actuator subsystem 50, a fluid interconnect subsystem 40, an electrofluidic transducer subsystem 90, and a plurality of fluidic chips 61. The fluid actuator subsystem 50, the plurality of fluidic chips 61, and the electrofluidic transducer subsystem 90 are all coupled, through mechanical connection and through numerous mating fluid channels, to the fluid interconnect subsystem 40. In addition, the fluid pumping device 3 is connected to the fluid interconnect subsystem 40 through hose barbs 41. Thus the fluid interconnect subsystem 40 plays a central role in the tactile actuation system 5, providing a means for mechanically securing all attached subsystems, and for routing fluid power and fluid signals between attached subsystems.

With reference to FIG. 2A, fluid channels within the fluid interconnect subsystem 40 of two types are shown: fluid power channels 42 and fluid information channels 43. The fluid power channels 42 are generally large bore and carry fluid at a constant elevated pressure with sufficient capacity for flow to maintain that pressure. Hose barbs 41 are mounted on the fluid interconnect subsystem 40 and provide a means to connect the fluid power channels 42 to the fluid pumping device 3. The fluid information channels 43 are generally small bore and carry fluid whose pressure varies between low and high values to encode information or control the operation of fluid logic circuits within the fluidic chips 61. Certain fluid information channels 43 carry signals encoding information with sufficient flow to inflate/deflate membranes 52 to form fluid actuators 53.

With reference to FIG. 2A, electrofluidic transducers 92 arranged on the edge of the fluid interconnect subsystem 40 convert electronic signals into pressure signals by gating the elevated pressure supplied by fluid power channels 42. The resulting fluid pressure signals are channeled by the fluid interconnect subsystem 40 to pressure-based inputs 74 of one or more fluidic chips 61. By arrangement of channels within one embodiment of the fluid interconnect subsystem 40, certain electrofluidic transducers 92 communicate with pressure-based inputs 74 of single fluidic chips 61, while certain other electrofluidic transducers 92 communicate with pressure-based inputs 74 that are shared across multiple fluidic chips 61. The pressure signals are processed within the fluid logic subsystem 60 (addressing and memory functions are performed) and output signals are produced as a result. The resulting pressure-based signals are routed to pressure-based outputs 75 of a fluidic chip 61. As a consequence of the addressing and memory functions, a given fluidic chip 61 has more pressure-based outputs 75 than pressure-based inputs 74. One pressure based output signal is dedicated to each actuator in the fluid actuator subsystem 50.

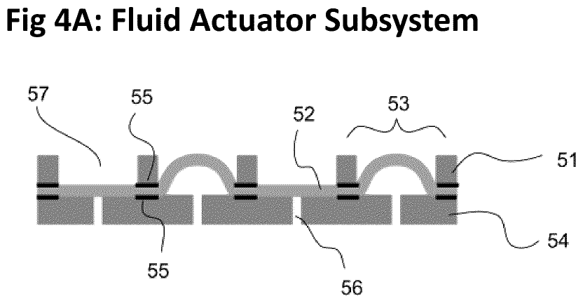

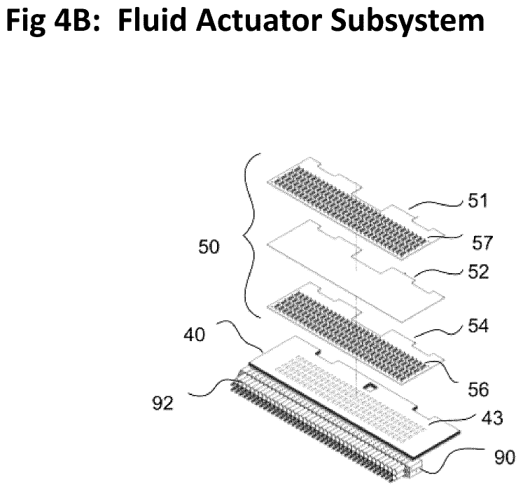

FIG. 2B shows a side view of the tactile actuation system 5 comprising the fluid actuator subsystem 50, electrofluidic transducer subsystem 90, fluid interconnect subsystem 40 and a fluidic chip 61. With reference to FIG. 2B, the pressure-based output 75 of a given fluidic chip 61 communicates with the fluid interconnect subsystem 40 through which the signal output is channeled to a fluid actuator 53 within the fluid actuator subsystem 50. In the embodiment shown in FIG. 2B, the fluid actuators 53 are housed within a fluid actuator subsystem 50 comprising a top plate 51, membrane 52, bottom plate 54, all bonded with pressure sensitive adhesive 55 (see for example, FIG. 4A). In alternative embodiments, the fluid actuator 53 is attached directly to the fluid interconnect subsystem 40.

With reference to FIG. 2C, a tactile actuation system 5 with a fluid logic subsystem 60 comprised of four fluidic chips 61 is shown upside down (with the fluidic chips 61 at the top of the drawing and the fluid actuator subsystem 50 at the bottom of the drawing). By intervening between the fluid actuator subsystem 50 and the fluidic chips 61, the fluid interconnect subsystem 40 enables fluid logic circuits 62 and fluidic actuators 53 to be formed within separate structures to further improve manufacturability and scalability of the device. Fluid logic circuits 62 (for example, see FIG. 5F) within the fluidic chips 61 whose function is dedicated to a single fluid actuator 53 can be scaled down well beyond the footprint of a fluid actuator 53. The scaling down of fluid logic circuits 62 leads to cost savings in the manufacture of the fluidic chips 61 in that fewer electrofluidic transducers 92 are required to serve the same number of fluid actuators 53. In one embodiment, fluidic chips 61 are formed by assembling molded layers of substrates with microchannels. The negatives for each layer are formed on a silicon wafer using standard photolithography processes. Individual layers are formed by casting polydimethylsiloxane (PDMS) over the negatives. Layers are then precisely aligned and bonded together to form a complex 3D structure or fluidic chip 61—with thousands of fluid logic circuits 62. Vias connecting microchannels within adjacent layers can be formed during or after the layer assembly process.

The process of assembling molded layers of microchannels to realize fluid logic circuits 62 results in a highly scalable manufacturing process analogous to chip manufacturing for semiconductors. Complex microchannel patterns are printed onto silicon wafers using ultraviolet light. This allows for mass production since molds for many logic circuits are created on a single wafer in one processing cycle. Each wafer can hold thousands of logic circuits, all processed in parallel, minimizing time and maximizing output. Smaller, denser designs, beyond the density of fluid actuators, lead to more logic circuits per wafer and thus higher yield per manufacturing run.

### Fluid Interconnect Subsystem (Fluidic Circuit Board)

With reference to FIG. 2B, the fluid interconnect subsystem 40 provides a common structure to facilitate the routing and distribution of fluid among the various system components. Fluid channels within the fluid interconnect subsystem 40 carry power (a constant high pressure with sufficient flow for any demand) and carry signal (information encoded in rapid variation of pressure). Certain power channels 42 carry power from the hose barbs 42 to to electrofluidic transducers 92 and fluidic chips 61. Certain signal channels 43 carry information from the electrofluidic transducers 92 to the fluidic chips 61, using minimal flow to maximize speed. Other signal conduits 53 carry information from the fluidic chips 61 to the fluid actuators 53, using sufficient flow to power the actuators.

In one embodiment, the fluid interconnect subsystem 40 also provides fluidic logic functions, incorporating fluidic circuits comprising membrane-based fluidic valves, fluidic resistors and capacitors. In addition to fluid routing, distribution, and logic functions, the fluid interconnect subsystem 40 provides mechanical functions, including mounting, alignment, assembly, and structural functions. In one embodiment, the fluid interconnect subsystem 40 serves as an enabling means to mount the electrofluidic transducers 92 and realize valve or gating function with integrated components (membranes, gaskets, or plungers). In addition, the fluid interconnect subsystem 40 provides a means to support tiling of certain components, and to provide an interface between components of distinct grid density, margin size (edge or border size,) or location.

The multi-functional nature of the fluid interconnect subsystem 40 is central to the realization of system function in that its efficient serving of these functions ensures minimum fluid volumes within fluid information channels 43. Minimizing volume maximizes the speed of signal transmission with the reduction of capacitive effects from either fluid compression or compliance within soft structure or interfaces.

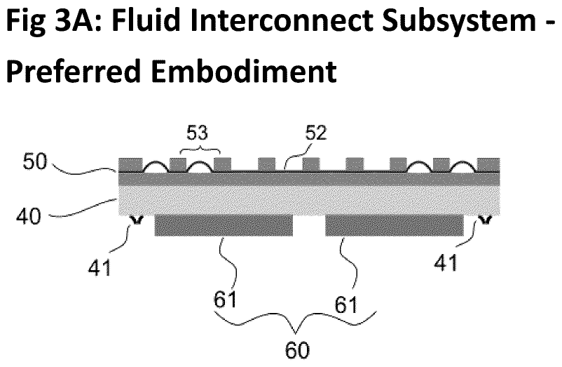

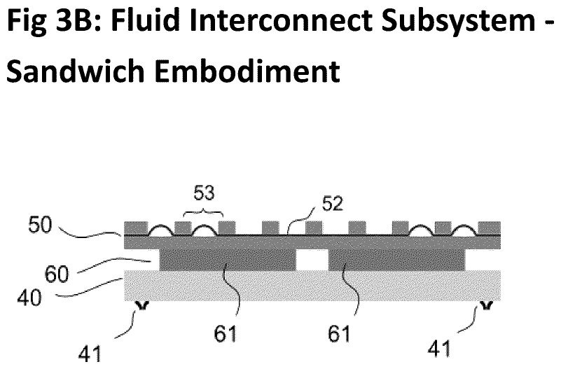

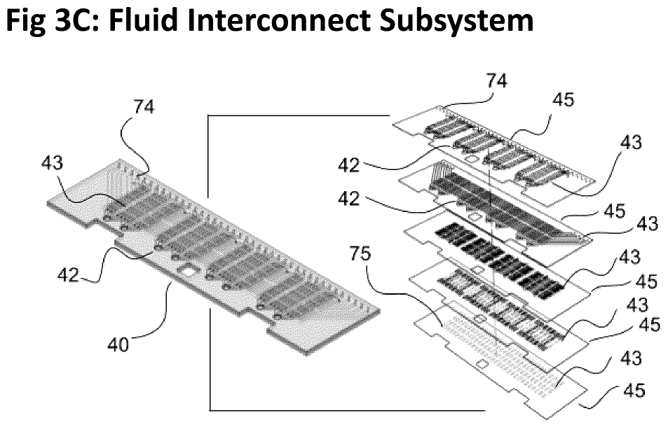

FIG. 3A and FIG. 3B show two possible embodiments for the fluid interconnect subsystem: one embodiment (FIG. 3A) positions the fluid interconnect subsystem 40 between the fluid actuator subsystem 50 and the fluidic chips 61 and another embodiment (FIG. 3B) positions the fluidic chips 61 between the fluid actuator subsystem 50 and the fluid interconnect subsystem 40.

The embodiment with the fluid interconnect subsystem 40 in the center (FIG. 3A) carries certain advantages over the embodiment with the fluidic chips 61 in the center. The embodiment with the fluid interconnect subsystem 40 in the center shall be called the preferred embodiment. The two outer subsystems can be directly manipulated without requiring an indirect method to align a middle structure. The total number of surfaces to be mated is reduced, reducing failure points. The thickness tolerance on the two mating subsystems (and/or any tiled subsystems) can be greatly relaxed, or even intentionally varied, since only a single surface of each subsystem must mate with a single surface of another. The preferred embodiment minimizes the fluid path length from the fluid logic subsystem 60 to the fluid actuator subsystem 50, which reduces dead volume. Reducing dead volume reduces the overall charge/drain time (thus increasing refresh rate), and also reduces power consumption since the pump requires less work to recharge the fluid paths. The preferred embodiment reduces manufacturing and assembly complexity of the fluid interconnect subsystem 40. Manufacturing tolerances are critical when routing thousands of outlet channels from the fluidic chips 61 to the corresponding array of fluid actuators 53. More closely integrating the fluid actuators and fluid interconnect subsystem 40 reduces stack-up tolerances through the entire structure. In addition the preferred embodiment overcomes limited mechanical and visual inspection access to ensure proper positioning of the inner sandwiched structures. Moreover, alignment aids (nominally fiducials) are difficult to visualize through the multiple layers.

With reference to FIG. 3C, a fluid interconnect subsystem 40 composed of five rigid substrate layers 45 is shown. In the example embodiment, fluid information channels 43 and fluid power channels 42 are formed in the rigid substrate layers through a machining process. In another embodiment, channels are formed in layers using a laser-engraving process. Layers are then precisely aligned and bonded together to form a complex 3D structure with many fluid information channels and power channels. In one embodiment, the rigid substrate layers are permanently bonded together with pressure sensitive adhesive 55. In another embodiment, the layers are bonded together through a surface activation process or thermal bonding process without the need for adhesives. Vias connecting channels within adjacent layers can be formed during or after the layer assembly process. In another embodiment, the fluid interconnect subsystem 40 and the channels are formed in an additive manufacturing process, e.g., 3D-printing using stereolithography (SLA) or fused deposition modeling (FDM). This reduces lengths (and dead volumes) of information channels as they can be routed in a direct line in 3D space rather than in-plane within a layer and through vias connecting layers.

With reference to FIG. 1D, overall fluidic operation is algorithmically controlled by the processor 32 within the electronic control system 30. Logic-level signals generated by the processor 32 are translated into electronic valve control signals within the tactile controller subsystem 33. Electronic valve control signals are then converted into fluidic control signals via the electrofluidic transducer subsystem 90, and then sent to the fluidic logic subsystem 60 through the fluid interconnect subsystem 40. Fluidic (preferably air) control signals are routed through paths (preferably channels or tunnels) within the fluid interconnect subsystem 40 to fluidic logic circuits in the fluid logic subsystem 60. Fluidic signals from a greater number of fluidic logic output ports are then routed through the fluidic interface layer to the fluid actuators in the fluid actuator subsystem 50.

In the preferred embodiment, the fluid actuator subsystem 50 and fluid logic subsystem 60 both comprise a tiled array of components. Tiling the components allows the structures to be custom-configured for various display aspect ratios. In addition, components with comparatively low fabrication yield can be individually evaluated and combined to produce a fully functioning larger display. As such, in the preferred embodiment, the fluid interconnect subsystem 40 is preferably a single structure the full size of the tactile display device 2 that also provides an overall mechanical support to the display.

To supply sufficient fluid volume within a short period of time to a given fluid actuator, a certain fluid flow is required. In the preferred embodiment, that flow is supplied directly from the fluid pressure supply through paths in the fluid interconnect subsystem 40. The flow may be gated, however, by low-flow pressure signals from the fluid logic subsystem 60. In an alternative embodiment, the fluid interconnect subsystem 40 includes one or more “buffers”. The buffer comprises a bank of pressure-controlled flow valves that gate pressure from a common high-pressure fluid supply through to the fluid actuators 53 under control of low-flow signals from the fluidic chips 61. Alternatively, the buffer structures are formed as an internal volume, accumulate fluid from a low flow source of the fluid logic subsystem 60, and then, being gated by a local valve on the fluid logic subsystem 60, rapidly release it when needed as high flow supplied to a fluid actuator 53. In an alternative embodiment, the fluid buffer structures include at least one elastic wall to store pressure energy.

In yet another alternative embodiment, the single large structure (the “substrate”) is preferably whichever of the fluid logic subsystem 60 or fluid interconnect subsystem 40 is most economical to produce at the desired full size, while the other subsystem may then be tiled.

In yet another embodiment, both the fluid logic subsystem 60 and fluid interconnect subsystem are fabricated as single large structures the size of the display. This increases the mechanical strength of the entire system.

In yet another embodiment, both the fluid logic subsystem 60 and fluid interconnect subsystem 40 are fabricated as smaller, independent structures and are themselves tiled to form a full-size tactile actuation system 5. Addressing function is achieved by connecting the fluid information channels 43 of the independent structures with air tubing 44. This increases the repairability and replaceability of the system wherein if one tactile dot is not working, the smaller, independent structure can be replaced.

### Fluid Actuator Subsystem

With reference to FIG. 4A, the preferred embodiment of the fluid actuator subsystem 50 is an elastic membrane 52 arranged between two rigid structures, referred to as the bottom plate 54 and the top plate 46. In the preferred embodiment, the elastic membrane 52 is a 100 μm thick silicone elastomer. The top plate 51 has a grid of regularly-spaced macro-scale holes 57 that define a tactile bubble array (1.8 mm diameter with 2.5 mm center-to-center spacing). The bottom plate 54 has a matching grid of regularly-spaced meso-scale ports 56 (2.5 mm center-to-center and <500 um diameter). The smaller diameter of the meso-scale ports 56 reduces the volume of fluid that must be displaced to inflate the elastic membrane 52 (reduce dead volume) thereby increasing fluid actuator speed. In addition, the use of meso-scale ports creates a floor against which both the uninflated elastic membrane 52 and the tactile dots 22 can seat. The tactile dots 22 are actuated (moved up or down) by the elastic membrane 52 as described below under the heading Tactile Output System. In the preferred embodiment, the rigid layers of the fluid actuator subsystem 50 are permanently sandwiched together with two layers of pressure sensitive adhesive 55. The layer of pressure sensitive adhesive 55 bonding the membrane 52 to the top plate 51 has a grid of holes whose geometry matches the macro-scale holes 57 in the top plate 51. Importantly, the layer of pressure sensitive adhesive 55 bonding the membrane 52 to the bottom plate 54 has a grid of holes whose geometry matches the macro-scale holes 57 in the top plate 51. The sizing of the holes to match the holes in the top plate 51 ensures that the membrane 52 does not bond to the bottom plate 54 and therefore can deflect upward to enable a fluid actuator. In an alternative embodiment, the layers are bonded together through a selective surface activation process without the need for adhesives. In the preferred embodiment, when there is a positive pressure difference across the membrane 52 between the internal port and the external ambient air, the membrane 52 deflects outward, forming a bubble whose outer diameter is constrained by the holes in the top plate 51. In an alternative embodiment, the membrane 52 is formed (preferably molded) to rest in the deflected (raised or outward deflected) state, with a reverse pressure differential causing the membrane 52 to retract toward the cavity.

With reference to FIG. 7C, in the preferred embodiment, the fluid actuators 53 are configured to displace tactile dots 22 of the user interaction system 20. Alternatively, the fluid actuators 53 can function directly as the tactile dots 22 in the user interaction system 20. In yet a further embodiment, an additional surface feature, such as a boss, may be incorporated into each membrane 52 to enhance their function as tactile dots 22.

With reference to FIG. 4B, the fluid actuator 53 is a membrane layer 52 without holes sandwiched between a top plate 51 and bottom plate 54, both of which feature a grid of holes. In one embodiment, bonding of layers is facilitated by layers of pressure sensitive adhesive 55 also prepared with a grid of holes. In an alternative embodiment, bonding of layers is facilitated by a surface activation process wherein layer surfaces are activated prior to assembly and form a bond upon contact with one another. Heat treatment may also be used to improve bond strength. Fluid Logic Subsystem (FIG. 5)

A fluid-powered tactile display device must be sufficiently compact and efficient to be portable. When combined with fluidic logic and integrated addressing, fluid actuation can achieve the required size and efficiency, as detailed in Patent U.S. Pat. No. 10,991,269 B2; “Microfluidic Actuators with Integrated Addressing”. FIG. 2A shows a schematic illustration of the tactile actuation system 5. The fluid logic subsystem is composed of a plurality of fluidic chips 61, each coupled to the fluid interconnect structure and each having a plurality of fluid logic circuits 62 within them. With reference to FIG. 2A, the fluid logic subsystem 60 translates a set of pressure-based inputs 74 generated from electrofluidic valves 92 into a much larger set of pressure-based outputs 75. Pressure-based outputs 75 of fluid logic circuits 62 are routed through fluid information channels 43 in the fluid interconnect subsystem 40 to a plurality of fluid actuators 53 in the fluid actuator subsystem 50. Fluid actuators 53 drive (i.e. extend and retract) tactile dots 22 arranged in a tightly-spaced grid (e.g., 2.5 mm center-to-center spacing with approximately 1.5 mm diameter features) contained in the user interaction system 20.

In the example embodiment in FIG. 5F, the fluid logic circuits 62 incorporated in the fluidic chips 61 are fluidic gated delay latches (D Latches) that operate analogously to electronic D Latches, as detailed in Patent U.S. Pat. No. 10,991,269 B2; “Microfluidic Actuators with Integrated Addressing”. FIG. 5E shows a schematic illustration of a fluidic D Latch. The D Latch is a fluid logic circuit that consists of two parts: a flip-flop 71 and a gated input 72. A fluidic flip-flop is a circuit with two inverters (also referred to as NOT gates) connected in a feedback loop. With reference to FIG. 5A, a fluidic inverter 70 generates a pressure-based output 75 opposite to a pressure-based input 74. Within the flip-flop 71, once the output of one inverter settles to a certain pressure level, the state of the flip-flop is latched. As such, flip-flops are useful in fluid logic circuits as basic memory elements. A fluidic D Latch is created by adding a gated input 72 to a flip-flop 71. The gated input has two pressure-based inputs, the data input 69 and the clock input 68. When the clock input 68 is at a low pressure (0), the normally-open fluid valve 64 is open and the data input 69 is able to forcibly change the state of the flip-flop and thereby change the state of the pressure-based output 75.

With reference to FIG. 5B, one embodiment of a fluidic inverter 70 is formed by placing a single pressure-controlled flow valve 63 in series with a load resistor 78 with high pressure 76 (connected to a fluid power channel 42) and low pressure 77 (connected to an atmospheric pressure channel 46) applied at separate ends of the series. FIG. 5C shows an alternative of another embodiment of a fluidic inverter 70. Two different embodiments of a pressure-controlled flow valve, one normally-open fluid valve 64 and the other normally-closed fluid valve 65 are paired in a complementary-symmetry structure (analogous to electronic CMOS logic) to create a basic inverter structure with negligible fluid flow in steady state. This reduces overall system fluid flow, which in turn reduces steady-state power consumption, improves state-change speed, and improves portability.

FIG. 5F shows a schematic illustration of a fluidic chip 61. D Latches 66 are arranged in an addressable grid within the fluidic chip 61. The addressable grid-based design enables row-by-row refreshing of the D Latches and their corresponding pressure-based outputs. Clock inputs 68 for D Latches sharing a row within the fluidic chip 61 are commonly connected to one pressure-based input 74. Data inputs 68 for D Latches sharing a column within the fluidic chip 61 are commonly connected to a pressure-based input 74. Therefore, the number of unique pressure-based inputs necessary to control all D Latches within the fluidic chip is equivalent to the summation of the number of rows and the number of columns of the grid. Pressure-based inputs generated by electrofluidic transducers 92 enter the fluidic chip through fluid information channels 43 and are carried along fluid information channels that extend across the chip in both horizontal and vertical directions to address D Latches at their intersections. Pressure-based outputs 75 generated by D Latches exit the fluidic chip through other fluidic ports and are carried along fluid information channels 43 that extend between the two surfaces of the fluid interconnect subsystem 40 and connect to fluid actuators 53 in the fluid actuator subsystem 50.

Of critical importance is the fact that there is a small delay between when a pressure-based input is received by a fluid logic circuit and when the pressure-based output becomes valid. The analogous phenomenon in electronics is referred to as a “propagation delay” and it limits the speed at which digital information (in the case of fluidic logic, pressure) can be reliably passed—or “clocked”—into a fluid logic circuit. In the example of a D Latch, in one ON-OFF cycle of the CLK input, or one “clock cycle duration”, 1 bit of information can be “latched” into the D Latch.

Due to the propagation delay of a fluid logic circuit, there is a maximum speed at which pressure-based inputs can be reliably “clocked” into a fluid logic circuit. Consequently, there is a maximum speed at which electrofluidic transducers 92 can apply pressure-based inputs and have them be reliably converted into pressure-based outputs by fluid logic circuits. The “clock cycle duration” then can be used to calculate the total time it takes to update all elements in an addressable logic circuit design.

With reference to FIG. 5G, in one embodiment of an addressable design, two D Latches can be arranged in series to achieve a fluidic latching memory unit similar in operation to a D Flip-flop in electronics. The second D Latch's clock input is connected to the first D Latch's clock input through an inverter circuit 70. The D Flip-flop 67 can itself be arranged in series with further D Flip-flops to achieve an addressable design similar in operation to an electronic shift register. The shift register-like fluidic structure serves as a latching register wherein two pressure-based inputs (e.g., clock and data) can control the state of an arbitrary number of pressure-based outputs. In the shift register embodiment, the total time to refresh the addressable array is equal to the clock cycle duration of the D Latch times the number of D Latches in the shift register.

In the grid-based embodiment in FIG. 5F, the total time to refresh the grid is equal to the clock cycle duration times the number of rows. In an alternative configuration, column-by-column refreshing could be implemented. In any case, the refresh scheme can be chosen such that when the user is interacting with tactile dots in one area of the tactile display, another area can be refreshed without disrupting the interaction experience. While some embodiments of addressable fluidic logic can further reduce the number of required electrofluidic transducers, e.g., a shift register design, the benefits of a grid-based approach are a faster full tactile display refresh rate (clock cycle duration times the number of rows) and the ability to arbitrarily refresh specific rows of the display.

### Electrofluidic Transducer Subsystem

The fluid signals that eventually operate the fluid actuators 53 must ultimately be interfaced to electronic signals from the electronic control system 30, in a fashion that provides high bandwidth and long lifetime. In the preferred embodiment, this is accomplished by one or more electrofluidic transducers 92. The transducers accept electric signals from the electronic control subsystem 30 and convert these into fluid signals of high and low pressure in channels that connect to the fluid logic subsystem 60.

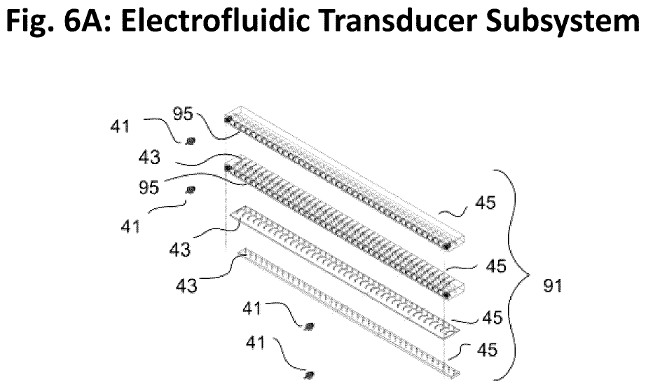

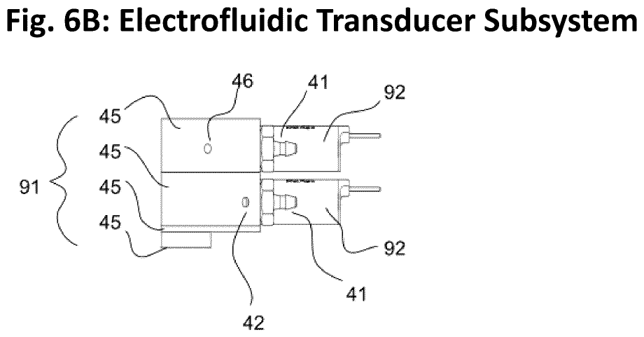

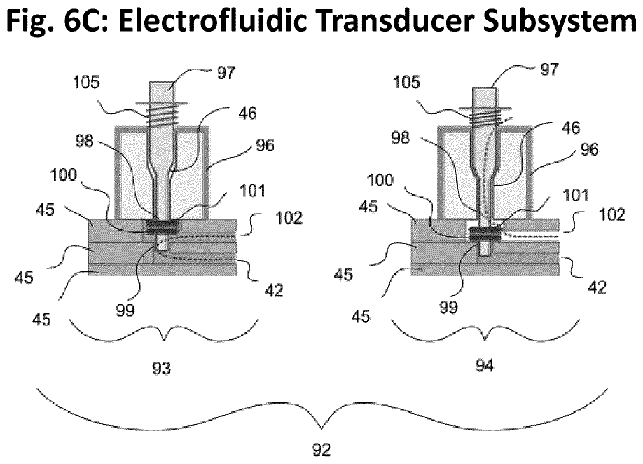

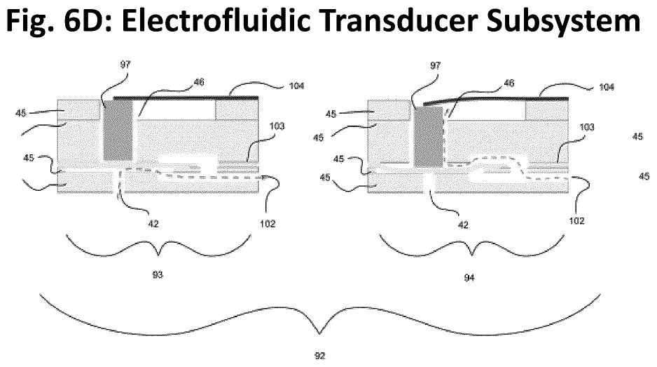

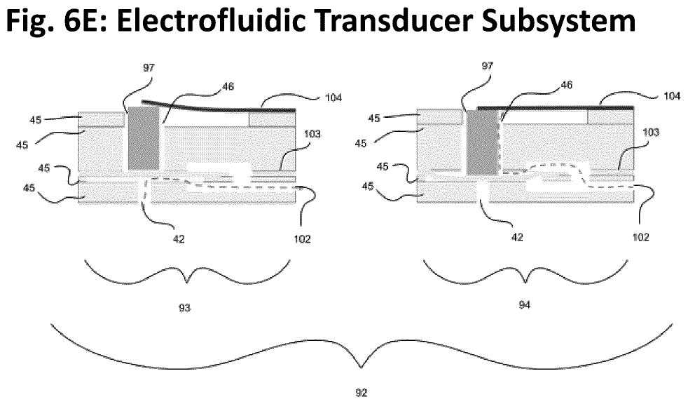

With reference to FIG. 6A and FIG. 6B, one embodiment uses plug-in style electrofluidic transducers 92 in the form of electromagnetic solenoids that drive piston valves to effect the conversion from voltage-based electrical to pressure-based fluidic signals. In this embodiment, a manifold 91 is assembled from four rigid substrate layers 45. One or more of the layers are machined with cylindrical holes 95 along one of their faces to interface to plug-in style electrofluidic transducers 92. One or more of the layers are machined with fluid information channels 43, fluid power channels 42, and atmospheric pressure channels 46 to supply fluid power and atmospheric pressure sources to the electrofluidic transducers 92 and carry pressure-based outputs generated by the electrofluidic transducers 92 to the fluid interconnect subsystem 40. In one embodiment, hose barbs 41 are attached directly to the manifold 91 and receive fluid power directly from the vented cable 4. In another embodiment, fluid power enters the manifold 91 through ports in the fluid interconnect subsystem 40.

With reference to FIG. 6C, in one configuration, a solenoid actuator 96 is assembled with a set of rigid substrate layers 45 into which channels are etched or cut. The solenoid plunger 97 and return spring 105 form a valve interface with holes within the rigid substrate layers 45. An upper O-ring 101 and Lower O-Ring 100 assemble to the solenoid plunger 97 to provide a soft seal against the surfaces of the underlying rigid substrate layers 45. When the solenoid plunger 97 is in the “up” position 93, fluid flows from the fluid power channel 42 port to the signal output 102 port. When the solenoid plunger 97 is in the “down” position 92, fluid flow is blocked at the normally-open orifice 99 and any pressure previously built up at the common port is vented to atmosphere out of the normally-closed orifice 98. In the embodiment shown in FIG. 6C, a solenoid actuator 96 moves the plunger 97 into the “down” position 94 when in an “energized” state and moves the plunger 97 into the “up” position when in an “unenergized” state. In an alternative embodiment, the solenoid is arranged such that the “up” position 93 is achieved in the “energized” state and the “down” position 94 is achieved in the “unenergized” state. To reduce the power consumption of the tactile display system, it may be advantageous to select one configuration over another based on which plunger position is more common when generating pressure-based inputs 74.

Alternative embodiments use piezoelectric, electrostatic, thermal, or any other force suitably generated from an electric control signal to drive a suitable valve structure such as a piston, spool, or poppet valve.

In an alternative embodiment, the valve structure in FIG. 6C can be replaced by a one that is integrated into a microfluidic substrate. With reference to FIG. 6D, a compliant membrane 103 within the substrate can be mechanically displaced by an electrically powered actuator (e.g., solenoid or piezoelectric bimorph). Displacement of the membrane 103 in turn closes a conduit or channel or closes an orifice that is internal to the microfluidic substrate. A plunger 97 can be incorporated to transmit the force applied by the actuator to the membrane 103.

With reference to FIG. 6D, in one embodiment, an array of electrofluidic transducers 92 is formed using a layered assembly process. Air channels and holes are etched or cut in rigid substrate layers 45 and assembled in a stack with an elastic membrane 103 to form a 3-way valve structure that is toggled by the displacement of a plunger 97. In a preferred embodiment, the rigid substrate layers 45 are formed from acrylic and the elastic membrane 103 is a soft silicone membrane with thickness 100 um). When the plunger 97 is in the “up” position 93, the signal output 102 is connected to the fluid power channel 42 at high pressure, and when the plunger is in the “down” position 94, the signal output 102 is connected to the atmospheric pressure channel 46 at low pressure (exhaust). One of the benefits of this embodiment is that a single soft/compliant elastic membrane 103 acts as the sealing member for an array of electrofluidic transducers 92 (valves) in a single layered substrate rather than separate gaskets and retaining rings as in the embodiment pictured in FIG. 6B. Another benefit of this embodiment is that it can be formed using a layered assembly process that is similar to the process used to form embodiments of the fluid interconnect subsystem 40 and the fluid actuator subsystem 50, which leads to reduced cost of manufacturing. In one embodiment, the plunger is driven by a piezoelectric bi-morph actuator 104 wherein the bimorph is mounted above the plunger 97 and embedded in the layered assembly 92.

With reference to FIG. 6D, in one embodiment, the plunger 97 is driven by a piezoelectric bi-morph actuator 104 wherein the unenergized bimorph is mounted in line with the top of the plunger when it is in its “up” position 93.

With reference to FIG. 6E, in an alternative embodiment, the bimorph is mounted in an unenergized state with the top of the plunger when it is in a “down” position 94. The benefits of this embodiment are that the elastic membrane 103 is pre-deflected into contact with the fluid power channel 42. Less actuator force and displacement is therefore required to close off the fluid power channel 42 from the signal output 102. Therefore, the piezoelectric bi-morph actuator 104 requires less voltage to operate, which is preferable for portable electronic systems for improved battery life and safety. The high pressure acts to push the fluid power channel 42 open when the piezoelectric bimorph actuator 104 is unenergized such that the signal output 102 still achieves high pressure in the de-energized state.

With reference to FIG. 6D and FIG. 6E, in these alternative embodiments, piezoelectric actuation is the preferred drive for the valves because of its high speed, minimal energy consumption, and minimal wear. Piezoelectric actuation can be used in this context (unlike the tactile dot context) because the required valve operation force scales directly with pressure and valve orifice size. For example, a relatively weak actuator of 0.1N closing force can be used to control a 20 psi (˜138 kPa) fluid line if an orifice approximately 1 mm in diameter is used for the valve. As well, because only a few transducers are required when fluidic logic is used, the actuators can be significantly larger than a braille character footprint.

Benefits of this approach include the following. An array of microvalves can be manufactured as part of a batch process (similar to the fluidic logic), reducing cost and failure points associated with discrete valve plumbing between the macro and micro scales. The microvalve seal operates primarily with tensile and/or compressive stress, preferably of a silicone membrane, which minimizes spalling When driven by a deflecting actuator with no sliding surfaces, such as a piezoelectric stack or beam, wear-causing friction and shear stress is likewise minimized, yielding an overall transducer structure (actuator and valve) with substantial lifetime compared to e.g. shuttle valves The small size reduces the total dead volume to a range commensurate with e.g. a 12 W pump achieving 1.5 SLPM at 20 psi. The actuator is likewise compatible with battery power. This dead-volume reduction is essential to compatibility with a portable power supply. In addition to compatibility with a battery supply, reduced pump size also means lower noise and less thermal dissipation to mitigate. The fast response time (typically in the 10s of milliseconds) of a piezoelectric actuator further reduces system latency, improving overall responsiveness and intuitive operation when touch gestures are used to initiate display changes User Interaction System

With reference to FIG. 7A, the user interaction system consists of the tactile output subsystem 21, the touch-sensing subsystem 23, and the button interface 24. The tactile output subsystem 21 provides information output to the user and a touch-sensing subsystem 23 and button interface 24 accept information input from the user. With reference to FIG. 7C, the tactile output subsystem 21 converts the motion of a plurality of fluid actuators 53 within the fluid actuator subsystem 50 into the motion of plurality of movable tactile dots 22.

### Button Interface

FIG. 7B shows a top-down view of an embodiment of the tactile display device 2 that features a button interface 24 alongside the tactile output subsystem 21 and touch-sensing system 23. The button interface 24 preferably includes a Perkins-style keyboard 29, programmable navigation keys 28, e.g., directional pad 27 and panning keys, and line select keys 26 that provide a means of selecting items from a list or routing a text cursor (positioning a cursor within a body of braille text).

### Tactile Output Subsystem

With reference to FIG. 7B, an exploded drawing depicts the various components of the tactile output subsystem 22. Tactile dots 22 are preferably implemented as mechanical pins that travel over a limited range of motion between a raised and lowered state as driven by the fluid actuator subsystem 50. Only eight tactile dots 22 are shown in FIG. 7B, in a design that accommodates an array of 1024 tactile dots 22. With reference to FIG. 7C, by design and assembly, a mechanical contact is established between each fluid actuator 53 within the fluid actuator subsystem 50 and each tactile dot 22 within the tactile output system such that displacement of a membrane 52 raises and lowers a corresponding tactile dot 22. In an alternative embodiment, the tactile dots 22 may be implemented as structures that provide a change of temperature, vibration, stiffness, resilience, compliance, diameter, shape, surface roughness, reciprocal motion, rotation, or other tactile characteristic achievable through a fluidic actuation mechanism. In yet another embodiment, the tactile dots may be physically integrated with the fluidic actuators (e.g. a molded-in feature or adhered component) to provide cost savings, ease of assembly, greater reliability, or other benefit.

The tactile output subsystem 21 preferably also includes a retaining structure to constrain the tactile dot 22 excursion. Such a retaining structure might include the plastic cover 25 shown in FIG. 7B and the touch-sensing subsystem 23 shown in FIG. 7C. If the embodiment includes a tactile output subsystem 21 within which the tactile dots 22 are constrained to move and a separately assembled fluid actuator subsystem 50 within which fluid actuators 53 are housed, the retaining structure ensures sufficient mechanical contact between each moving tactile dot 22 and its corresponding fluid actuator 52. Alignment and tolerancing ensures that each actuator consistently toggles its corresponding tactile dot 22 between raised and lowered states. Touch-sensing structure

The touch-sensing subsystem 23 monitors the position and movement of a user's fingers on the device surface to detect user behavior and user input. User input includes commands and control signals issued by the user to the device in the form of gestures or actions that are recognized by the touch-sensing subsystem 23. Gestures that may be recognized include (but are not limited to) simple (one-finger) touches, as well as compound touches, pinches, swipes, single-or multi-taps, and other gestures generally known to the computing industry. Detectable gestures might also include multi-finger (two, three, or more finger) touches and multi-finger touch movements. The touch-sensing structure is preferably a capacitive touch-sensing structure, but may also use a resistive sensing, strain sensing, mechanical force-sensing, reflected-light-sensing, transmitted-light-sensing, or other suitable structure and means. The touch-sensing subsystem 23 is preferably located proximate to the tactile surface of the subsystem, where it is best able to detect touch without loss of signal through intervening materials. In yet another embodiment, the system detects touch or gestures using a pressure-sensing structure to monitor touch-induced back-pressure in the channels connected to the fluidic actuators.

In the preferred embodiment, the touch-sensing structure (in conjunction with the control system) supports “smart” rendering of tactile features, whereby the areas of the screen that a user is not exploring (as determined by sensing the user's touch location) can be refreshed without disrupting their experience (“in the background”).

In another preferred embodiment, the touch-sensing subsystem 23 operates in conjunction with the touch output system 22 and underlying fluid actuator subsystem 50 to support rendering of tactile features that cause the user to perceive the surface deforming under (or conforming to) the motions of their finger on the surface. For example, raised dots would lower as the user's finger moves over them, giving the user the impression that they are performing mechanical work on the dots, re-forming them into lowered states. Or, in other types of interactions, lowered dots would be raised as a finger moves over them, prompting the user to move in certain directions or to produce certain gestures. The timing and position of the dots raising or lowering under a stationary or moving finger, relative to the instantaneous position of the finger, provides a palette with which to induce various perceived behaviors of the active substrate. The richness of this palette provides support for interaction design whose aim is to create intuitive and explainable user interfaces.

In the preferred embodiment, the touch-sensing structure also provides diagnostic functions. For example, using dot structures that create a measurable change in physical characteristics at the touch-sensing surface allows detection of the state of the dots, yielding a dot-by-dot self-test function.

### Electronic Control System

The control subsystem operates the actuation layer and monitors the touch-sensing structure to facilitate user interaction with information presented on the display device. The presented information may be obtained from the device itself (e.g. onboard software) or from a separate source, such as a host computer.

The control system comprises:
1. An electronic circuit board, including:
   a. A microprocessor that manages operation of the display. The microprocessor preferably supports an on-board operating system and one or more software applications
   b. Drive circuitry to send signals to the electrofluidic transducers
   c. Interface circuitry to accept signals from the touch interface.
   d. Wireless/wired communication ports, preferably chosen from (but not limited to) the set of (Bluetooth, WiFi, USB, HDMI, SD card slot). Any other suitable configuration and/or protocol may also be used.
2. A system for providing power to operate the display. The system preferably includes an integrated battery equipped with a charging/conditioning circuit to accept power from an external source. In alternative embodiment, it can accept operating power from an external source. As yet another embodiment, the system may accept a removable battery for replacement upon reaching a discharged state.

### Fluid Pumping Device

With reference to FIG. 1D, a fluid pumping device 3 comprises a fluid pumping system 111, an air dryer system 114. and an audible noise suppression system 113. Operation of the fluid actuator subsystem 50 requires a source of pressurized fluid or fluid power source, much as an electronic circuit requires an electrical power source (e.g. a battery). In the preferred embodiment, the system uses pressurized air for the fluid, with the fluidic power provided by a fluid pumping system 111 that creates a positive pressure differential relative to the ambient atmosphere. In an alternative embodiment, cartridges of compressed air or other fluid may be used, although the lifetime of a cartridge will likely be shorter than the equivalent volume of an electrical pump and battery power supply. Furthermore, in a fluidically-driven system, the tactile force (or “stiffness”) experienced by the user is a direct function of the fluid supply pressure. In the preferred embodiment, at least 18 psig is provided to the fluid actuator structures.

In the preferred embodiment, the fluid pumping system 111 provides a pressurized air supply to the electrofluidic transducers 92 and the fluid logic subsystem 60. The nominal target pressure is 18 psig to provide a resilient tactile feel to the user, but can be varied (e.g. raised for faster operation, or lowered to reduce power consumption). The fluid pumping system 111 is operated in a constant-speed mode, relying on the pump's terminal pressure to control peak pressure output. Alternatively, a separate pressure regulator can be used, or pump drive controller equipped with a pressure sensor to monitor and control the pressure differential.

Filter 127 is used when the pump system is likely to be in environments requiring filtration of fine particulates that might otherwise foul the pumping system or display. The filter preferably traps particulates >1 μm diameter.

When ambient air is compressed, the moisture-carrying capacity increases due to a temporary rise in temperature from compression; however, the density of the moisture (that is, the relative humidity, or % RH) increases as a consequence of compression. When the % RH exceeds 100%, moisture will condense out into droplets. As well, if/when the air cools again, additional condensation may occur as the water capacity decreases. Condensed moisture droplets intermixed with supply air will cause the display to operate erratically, as the extreme difference in viscosity between air and water will disrupt the precise logic timing necessary for the display to operate correctly. Accordingly, sufficient moisture must be removed from the air to prevent any condensation of water in the pneumatic display logic circuits. (Note that complete dehumidification, however, is not necessary.)

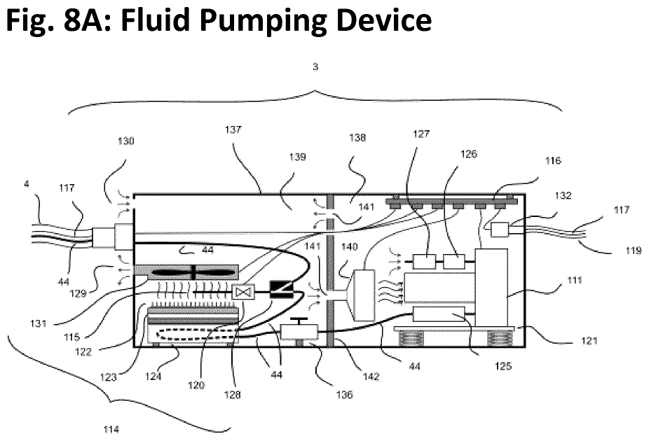

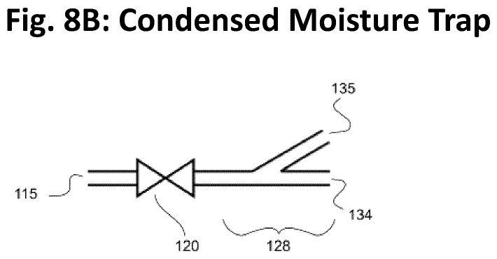

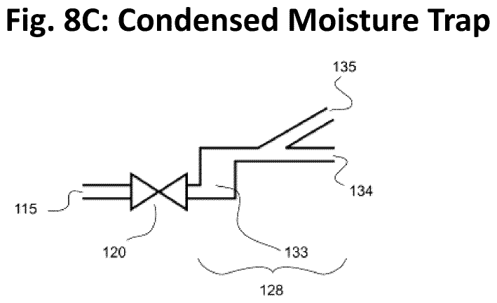

In the preferred embodiment, with reference to FIG. 8A, air drying system 114 accepts moisture-laden air from the pumping system 111 via conduit 44, preferably a compliant tube such as silicone tubing to minimize transfer of pump vibration to the rest of the system. Pressure regulator 136 is preferably used to limit the higher pressure of pump 111 at low flow rates so it does not exceed the target working pressure of air dryer 114 and the downstream display module. The dryer cools the air in cooling block 124 to condense out excess moisture, preferably using a thermoelectric cooling (TEC) module 123 to chill the block. The air is preferably cooled to a few degrees below room temperature (4° C. below room temp in the preferred embodiment) so that under typical operating conditions, the air will either maintain temperature or perhaps warm a few degrees as it continues downstream along conduit 44 and finally toward the tactile display device 2 within the vented cable 4, thus avoiding further condensation past trap 128.

Condensed moisture is collected in trap 128 and periodically expelled from the trap by the internal air pressure when the trap ejection valve 120 is opened, preferably for 150 msec every 5 min of operation. The ejection cycle can be any suitable cycle timing that ensures accumulated moisture is ejected before it reaches sufficient quantity to leak into, get blown into, or otherwise become redispersed into the air leaving the outlet port of the trap. Note that, with reference to FIG. 8B, trap 128 preferably has a backward-facing acute angle for air outlet 135 relative to the angle of air inlet 134, to further minimize the likelihood of water droplets being blown from the trap reservoir (just before valve 120) into the outlet path. (That is, the incoming air will tend to drive water further toward the trap ejection valve 120 rather than the air outlet port.) Furthermore, with reference to FIG. 8C, the reservoir preferably includes a weir 133, to further prevent reintroduction of water into the outlet port.

Expelled moisture is dispersed by drain line 115 onto the surface of heatsink 122, where it is preferably re-evaporated to room ambient by the TEC waste heat dissipated from the heatsink, assisted by convective airflow from fan 131. Fan airflow is preferably downward, using turbulence to minimize stagnant air pockets on the heatsink. The heated, moisture-laden air is then exhausted directly to the ambient environment by port 129, while make-up air is brought in through port 130.

With reference to FIG. 1D, the audible noise suppression system 113 is configured to attenuate noise generated from the fluid pumping system 111.

In one preferred embodiment, with reference to FIG. 8A, the noise is suppressed by enclosure 137 whose walls are preferably a lamination of materials with different acoustic impedances to increase attenuation spectrum and effectiveness. In the preferred embodiment, the enclosure walls consist of a rigid, dense material such as aluminum with a wall thickness >1.5 mm laminated to a layer compliant, dense material (such as neoprene rubber) with thickness >2.4 mm.

Although the best noise attenuation can be achieved with a fully sealed housing, heat buildup in the pump cavity becomes difficult to remove. As such, enclosure 137 is further subdivided into pump compartment 138 and air dryer compartment 139. Pump compartment 138 preferably includes inlet and outlet openings 141 for air exchange. The preferred embodiment further uses a blower 140 with high static pressure (preferably >0.5 inH2O) and moderate free air flow (preferably >5 cfm) to obtain significant air exchange while allowing air exchange openings 141 to be relatively small (8 mm ID in the preferred embodiment) to minimize noise leakage. In the preferred embodiment, the openings for air exchange 141 are configured as two Helmholz resonator ports, allowing air exchange while minimizing sound leakage when tuned to a response minimum at the fundamental noise frequency of the pump. For example, an enclosure design with an approximate 580 cm3 internal volume is optimized for minimal noise with each port having 43 mm path length and 4.75 mm internal diameter.

As part of the noise suppression system, the fluid pumping system 111 itself is mounted to a spring-supported stage 121 to minimize vibration transfer to the enclosure 137. In the preferred embodiment, three springs with spring constant k=5.2 lbf/in (˜57N/cm) minimize vibration transfer while also providing adequate support to the pump, which has a mass of 640 g. In the preferred embodiment, the fluid pumping system 111 is housed in a separate enclosure from the tactile display device 2 to minimize noise and vibration to the user. In an alternative embodiment, the fluid pumping system 111 can be integrated directly into the tactile display device 2 for ease of portability.

As another part of the noise suppression system, inlet muffler 126 attenuates noise from the pulsing of the pump inlet. The combined volume of inlet muffler 126 and output buffer tank 125 are also preferably used to tune the air impedance of the system to maximize the pump efficiency.

The enclosure is preferably designed such that the “dry” side 138 where the pump and control electronics are located is isolated from condensate on the “wet” side 139 where the condensed water is dispersed to the heatsink and reevaporated to ambient. This is preferably accomplished by sealing partition 142 so that the only openings are the two air-exchange ports 141. Furthermore, preferably using cantilevered tubes for the tuned ports 141 provides a further impediment to stray droplets traveling from the “wet” side 139 to the “dry” side 138 of the system by making the crossover path more tortuous.

The water trap is most effective when the pumping system is upright, as gravity works to reinforce water movement towards the valve. As such, in the preferred embodiment, a tip sensor is included on the electronic control board 116 to alert the user when the pumping system is oriented in a less favorable position.

The entire pump system is managed by electronics control board 116. In the preferred embodiment, the board accepts power from a power source, preferably a 24 VDC universal power supply, connected to DC jack 132 by conductor path 117 in cable 119 from the power supply. The board connects to each of the onboard components, as well as sharing input electrical power between itself and the downstream display via electrical power conductor path 117. The vented cable 4 also preferably includes the ability to communicate with the display via a subset of leads in conductor path 117. Communication preferably includes the ability for the display to enable/disable the pump and monitor the operating condition of the pump system, e.g. temperature.

In lieu of air, an incompressible fluid such as water is an alternative for a design using fluid paths with large dead-volume (and potentially low flow) to minimize the charge/discharge time of fluidic state changes. Low-viscosity fluids are preferred for fluid paths with small cross-sectional flow areas.

Fluids chosen for certain environment-specific characteristics are yet another alternative; for example, using a fluid with low freezing temperature in a scenario where the device operation below the freezing point of water is necessary.

Finally, a combination of fluids with different densities and/or viscosities may be chosen to optimize the system performance; for example, a low-viscosity fluid can be used to obtain fast operation of the fluidic logic, while a high-viscosity fluid is then used in the actuators to alter the tactile “feel” of the tactile interface.

An alternative embodiment of the fluid pressure supply provides at least two different pressure outputs, allowing the system to run with different pressure levels. This would, for example, allow operation of the fluidic logic at a lower pressure (thus reducing tensile stresses in the fluidic logic) while a “buffer” output from logic structure would manage the higher pressure necessary for driving the actuator bubbles. Alternatively, the fluidic logic could run at higher pressure for faster operation, but use reduced pressure in the actuators to provide a “softer” tactile feel to the user.

### Benefits of the Preferred Embodiment

Of critical importance to the user experience, the high degree of integration between the fluid actuator subsystem 50, user interaction system 20, and electronic control subsystem 30 in the described invention allows rapid response to user inputs and responsive feedback to user actions. The refresh speed must be sufficient to support low end-to-end latency, such that the user experience is truly intuitive. Response times can be quantified in terms of refresh of the entire tactile array (which are expected to be complete within seconds,) or actuation of individual dots under a moving finger (which must take place within tens of milliseconds).

The ability to respond to real-time gesture-based functions has many important benefits, demonstrating that the particular, described, inventive combination of the key components is greater than the individual components themselves. Features that the described invention can uniquely support include:
when the user taps on an area of the screen, the screen can update the tactile displayed information within that area in response. (By contrast, a refresh rate of e.g. 2 seconds is too slow to be intuitive and instead would only confuse and frustrate the user.)
providing panning and zooming capability, e.g. a double-tap at a braille character location can move the touch cursor to that location
multi-point touch input (e.g. for pinch-to-zoom)
a haptic buzz or vibration, provided either by the fluidic actuator system or by other means, can provide a user with underlying information about the tactile information they are feeling; for instance, there may be descriptive information embedded that, by using a double-tap gesture at that location, would reveal more information about the element
A tone or text-to-speech audio output can be synchronized with a user's finger location. For example, in rendering of data in a chart or graph, as a user drags their finger across the display, a tone of increasing frequency may provide information regarding the magnitude of the underlying data along the y-axis as the user drags left and right across the x-axis
The response of the pins (produced by our actuators) to sensed actions of the user (e.g., whether the user is moving their finger or is varying applied force) is under program control. That response can be controlled to give the user the impression that certain tactile features are immutable while others are mutable, or that some pins feel like clay while others are soft to the touch like felt or silk. By coordinating a user's sensed finger movements and the actuated motion of pins under the fingers, the user will be given the impression that they are touching pins with various material properties.

What is claimed is:

1. An interconnect layer intervening between a plurality of electrofluidic transducers, a plurality of microfluidic components, and a plurality of fluidic actuators, the electrofluidic transducers providing a means to transduce electronic signals to signals encoded in fluid pressure and flow, the microfluidic components providing addressing, memory, and multiplexing functions that result in a larger number of fluidic signals, and the fluidic actuators providing displacements as driven by the fluidic signals.
